(19) United States
(12) Patent Application Publication
(10) Pub. No.: US 2026/0107066 A1
(43) Pub. Date: Apr. 16, 2026

(54) Smooth Continuous Zooming in a Multi-Camera System by Image-Based Visual Features and Optimized Geometric Calibrations

(71) Applicant: Google LLC, Mountain View, CA (US)

(72) Inventors: Chucai Yi, Fremont, CA (US); Youyou Wang, Cupertino, CA (US); Hua Cheng, New Taipei City (TW); Chia-Kai Liang, San Jose, CA (US); Fuhao Shi, San Jose, CA (US)

(21) Appl. No.: 19/116,139

(22) PCT Filed: Sep. 25, 2023
(86) PCT No.: PCT/US2023/033577

§ 371 Date: Mar. 27, 2025

Related U.S. Application Data
(60) Provisional application No. 63/377,581, filed on Sep. 29, 2022.

(51) Int. Cl. H04N 23/69; H04N 23/61; H04N 23/63; H04N 23/68; H04N 23/90

(52) U.S. Cl. CPC H04N 23/69; H04N 23/61; H04N 23/632; H04N 23/683; H04N 23/90

(57) ABSTRACT

An example method includes displaying an initial preview of a scene being captured by a first camera operating within a first range of focal lengths. The method includes detecting a zoom operation predicted to cause the first camera to reach a limit of the first range. The method includes activating a second camera, operating within a second range of focal lengths, to capture a zoomed preview of the scene. The method includes updating a geometry-based warping transformation based on a comparison of respective image features from the initial preview and the zoomed preview. The method includes aligning the zoomed preview with the initial preview by applying the updated warping transformation. The method includes displaying the aligned zoomed preview of the image captured by the second camera while operating within the second range.

### CROSS-REFERENCE TO RELATED APPLICATIONS/INCORPORATION BY REFERENCE

This application claims priority to U.S. Provisional Patent Application No. 63/377,581, filed on Sep. 29, 2022, which is hereby incorporated by reference in its entirety.

### BACKGROUND

Many modern computing devices, including mobile phones, personal computers, and tablets, include image capture devices. Some image capture devices are configured with multi-camera systems. The camera systems are configured to use their respective specifications to collaboratively meet different image capturing requirements. A smart phone can integrate multiple types of cameras with a variety of focal lengths to take care of objects in different distances and scenes in different fields of view (FOVs).

### SUMMARY

The present disclosure generally relates to a smooth transition between multiple cameras. In one aspect, an image capture device may include multiple cameras. Transitioning between cameras may result in perceptible image distortions such as binocular disparity, for example, due to a change in a field of view. As described herein, a warping transformation is estimated from available geometric metadata as well as image based data to warp the image of one camera to be almost aligned with the image of the other camera, thereby reducing the perceptible image distortions during a camera switch.

In a first aspect, a computer-implemented method is provided. The method includes displaying, by a display screen of a computing device, an initial preview of a scene being captured by a first image capturing device of the computing device, wherein the first image capturing device is operating within a first range of focal lengths. The method also includes detecting, by the computing device, a zoom operation predicted to cause the first image capturing device to reach a limit of the first range of focal lengths. The method further includes, in response to the detecting, activating a second image capturing device of the computing device to capture a zoomed preview of the scene, wherein the second image capturing device is configured to operate within a second range of focal lengths. The method additionally includes updating a geometry-based warping transformation based on a comparison of respective image features from the initial preview and the zoomed preview. The method further includes aligning the zoomed preview with the initial preview by applying the updated warping transformation, wherein the updated warping transformation reduces one or more viewing artifacts caused by a change in a field of view when transitioning from the initial preview to the zoomed preview. The method also includes displaying, by the display screen of the computing device, the aligned zoomed preview of the image captured by the second image capturing device while operating within the second range of focal lengths.

In a second aspect, a computing device is provided. The computing device includes a display screen, a first image capturing device configured to operate within a first range of focal lengths, a second image capturing device configured to operate within a second range of focal lengths, one or more processors, and data storage, wherein the data storage has stored thereon computer-executable instructions that, when executed by the one or more processors, cause the mobile device to carry out functions. The operations include displaying, by the display screen, an initial preview of a scene being captured by the first image capturing device; detecting, by the computing device, a zoom operation likely to cause the first image capturing device to reach a limit of the first range of focal lengths; in response to the detecting, activating the second image capturing device to capture a zoomed preview of the scene; updating a geometry-based warping transformation based on a comparison of respective image features from the initial preview and the zoomed preview; aligning the zoomed preview with the initial preview by applying the updated warping transformation, wherein the updated warping transformation reduces one or more viewing artifacts caused by a change in a field of view when transitioning from the initial preview to the zoomed preview; and displaying, by the display screen of the computing device, the aligned zoomed preview of the image captured by the second image capturing device while operating within the second range of focal lengths.

In a third aspect, an article of manufacture is provided. The article of manufacture may include a non-transitory computer-readable medium having stored thereon program instructions that, upon execution by one or more processors of a computing device, cause the computing device to carry out operations. The operations include displaying, by the display screen, an initial preview of a scene being captured by the first image capturing device; detecting, by the computing device, a zoom operation likely to cause the first image capturing device to reach a limit of the first range of focal lengths; in response to the detecting, activating the second image capturing device to capture a zoomed preview of the scene; updating a geometry-based warping transformation based on a comparison of respective image features from the initial preview and the zoomed preview; aligning the zoomed preview with the initial preview by applying the updated warping transformation, wherein the updated warping transformation reduces one or more viewing artifacts caused by a change in a field of view when transitioning from the initial preview to the zoomed preview; and displaying, by the display screen of the computing device, the aligned zoomed preview of the image captured by the second image capturing device while operating within the second range of focal lengths.

In a fourth aspect, a system is provided. The system includes means for displaying, by the display screen, an initial preview of a scene being captured by the first image capturing device; means for detecting, by the computing device, a zoom operation likely to cause the first image capturing device to reach a limit of the first range of focal lengths; in response to the detecting, means for activating the second image capturing device to capture a zoomed preview of the scene; means for updating a geometry-based warping transformation based on a comparison of respective image features from the initial preview and the zoomed preview; means for aligning the zoomed preview with the initial preview by applying the updated warping transformation, wherein the updated warping transformation reduces one or more viewing artifacts caused by a change in a field of view when transitioning from the initial preview to the zoomed preview; and means for displaying, by the display screen of the computing device, the aligned zoomed preview of the image captured by the second image capturing device while operating within the second range of focal lengths.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates binocular disparity in a multi-camera system, in accordance with example embodiments.

FIG. 2 is a flowchart of a workflow for an image-based computation of a warping transformation, in accordance with example embodiments

FIG. 3 is an example sparse feature workflow for smooth continuous zooming in a multi-camera system, in accordance with example embodiments.

FIG. 4A illustrates temporal feature matching and tracking, in accordance with example embodiments.

FIG. 4B illustrates example images for temporal feature matching and tracking, in accordance with example embodiments.

FIG. 4C illustrates an example application 400 of temporal feature matching and tracking, in accordance with example embodiments.

FIG. 5 is an example dense feature workflow for smooth continuous zooming in a multi-camera system, in accordance with example embodiments.

FIG. 6 illustrates example handling of delta data during camera transitions, in accordance with example embodiments.

FIG. 7 is a table illustrating various cases for switching between a tele camera and a wide angle camera, in accordance with example embodiments.

FIG. 8A depicts an example geometric relation at each pair of matched pixels, in accordance with example embodiments.

FIG. 8B depicts a workflow to determine a geometric relation at each pair of matched pixels, in accordance with example embodiments.

FIG. 9 depicts an example workflow for smooth continuous zooming in a multi-camera system, in accordance with example embodiments.

FIG. 10 depicts a distributed computing architecture, in accordance with example embodiments.

FIG. 11 is a block diagram of a computing device, in accordance with example embodiments.

FIG. 12 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

A smart phone or other mobile device that supports image and/or video capture may be equipped with multiple cameras using respective specifications to collaboratively meet different image capturing requirements. A smart phone can integrate multiple types of cameras with a variety of focal lengths to display and/or capture objects at different distances, and scenes in different fields of view (FOVs).

For example, a phone may be configured with a main camera with a medium focal length to meet normal photo/video capture requirements, a telescope camera with a longer focal length to capture remote objects, and an ultra-wide camera with a shorter focal length to capture larger FOVs. During the photo/video capture session, a switch from the main to the telescope camera may occur when a user continues to zoom-in for the in-focus of a remote object, and a switch from the main to the ultra-wide camera may occur when the user continues to zoom-out to capture a larger field-of-view. Multi-camera systems provide a much larger range of focus distances than a single camera. However, an abrupt camera switch while zooming may cause a view discrepancy (known as “Binocular Disparity”).

To circumvent the binocular disparity, a warping transformation may be estimated from the available geometric metadata and image features to warp the image of one camera to be almost aligned with the image of the other camera, so that changes during a camera switch are less perceptible. Warping transformations can involve scaling, rotation, reflection, an identity map, a shear, or various combinations thereof. Also, for example, translations, similarities, affine maps, and/or projective maps may be used as warping transformations. Generally speaking, two planar images can be related by a warping transformation, such as a homography. For example, a computer vision approach to computing a homography may be used that can warp the image frame from one camera to another. As described herein, a homography computation can be determined to reduce the view discrepancy during a camera switch while zooming. The homography computation can use geometric information (without image features) including metadata such as camera calibration data, focusing distance, and so forth. Although a geometry-based solution may be used, presence of electrical and/or mechanical parts, such as Voice Coil Motors (VCM), optical image stabilization (OIS) adjustments, and/or thermal effects of a device may cause dynamic camera calibrations and changes in focus distances that may result in errors in determining an accurate warping transformation for a smooth viewing experience, thereby resulting in the abrupt transitions.

Some existing approaches attempt to solve this problem. For example, views of physical cameras may be warped to the same coordinate, and the warping transformation may depend on camera calibrations and focal distances. However, image-based features are not used, and so the errors resulting from VCM/OIS adjustment and/or thermal effects may remain uncorrected. Another approach may be to blend multiple camera views, and apply a fading-style animation to obtain smooth switches. However, this approach depends on a simultaneous display of images from different cameras. A theoretical model for using binocular disparity and motion parallax for depth estimation has been proposed, but this does not have any practical implementations to solve the technical problems related to image capturing devices.

This application relates to an “image-based” approach (sometimes referred to herein as ContiZoom) to better assist the warping quality to overcome the adverse effects of a VCM/OIS adjustment and/or thermal effects. In contrast to the “geometry-based” approach, the new “image-based” approach is designed to utilize image information and/or features as extra input to improve the warping transformation used in the geometry-based approach.

The approach described herein makes direct use of image features to provide a more accurate metric for computing the warping transformation. This reduces spatial differences between the image frames between the two cameras, and mitigates the impact of many inaccurate sensor metadata from the geometry-based approach.

From a geometric point of view, thermal changes to the device affect the principal points, which may cause the entire FOV to shift, and this in turn causes the output from the camera parameter interpolation (CPI) to be unreliable. Thermal changes impact the focusing distance; and therefore, with each successive frame, and with continued use of the device, the already-inaccurate focusing distance may become more unstable with additional thermal impact.

These factors may be mitigated in large part by utilizing image information (features) to adjust inaccurate geometric metadata. For example, image feature matching may be performed between two frames from two different physical cameras. The existing geometric metadata may be corrected based on the image features. The geometry-based warping transformation may be re-computed based on the geometric metadata that has been corrected based on image features.

As described herein, dual images from the pair of cameras under switching are used for the image-based smooth zooming described herein. In the event that the continuous zooming quality is negatively impacted by thermal changes or inaccurate estimation of focus distances, image-based visual information can effectively resolve the resulting issues. Bundle adjustment may be applied to the camera calibrations and the world points from visual feature matches, so that the optimized parameters generate a more reliable homography for image warping. Scene depths may be estimated from both image-based visual features and phase differences, resulting in improved smoothness of the zooming under camera switches.

In some embodiments, the image-based algorithmic processes may be performed at up to 30 frames per second (fps), and can be configured to work seamlessly with other camera features such as image distortion correction, video stabilization, and so forth. Computationally intensive steps, such as visual feature extraction, may be rendered less intensive by the use of multi-threading and DSP solutions.

There are several benefits of using image-based visual features, including that images (e.g., in regular RGB format) may be made conveniently available from the camera system of a device. As image alignment during camera switching is a desired outcome of continuous zooming, a warping estimated from the image itself is more reliable and suitable. Such a warping effectively combines the image-based visual features with the geometry-based calibrations and focus distances, thereby improving the smoothness and stability of the zooming under camera switches.

As such, the herein-described techniques can improve image capturing devices equipped with multi-camera systems by reducing and/or removing visual discrepancies in images and/or videos during camera transitions, thereby enhancing their actual and/or perceived quality. Enhancing the actual and/or perceived quality of photos or videos can provide user experience benefits. These techniques are flexible, and so can apply to a wide variety of videos, in both indoor and outdoor settings.

In what follows, the term “homography” is used to refer to an implementation of a warping transformation. Also, for example, terms such as “warped,” “warping,” etc. may be used in the context of applying a warping transformation.

### Smooth Continuous Zooming

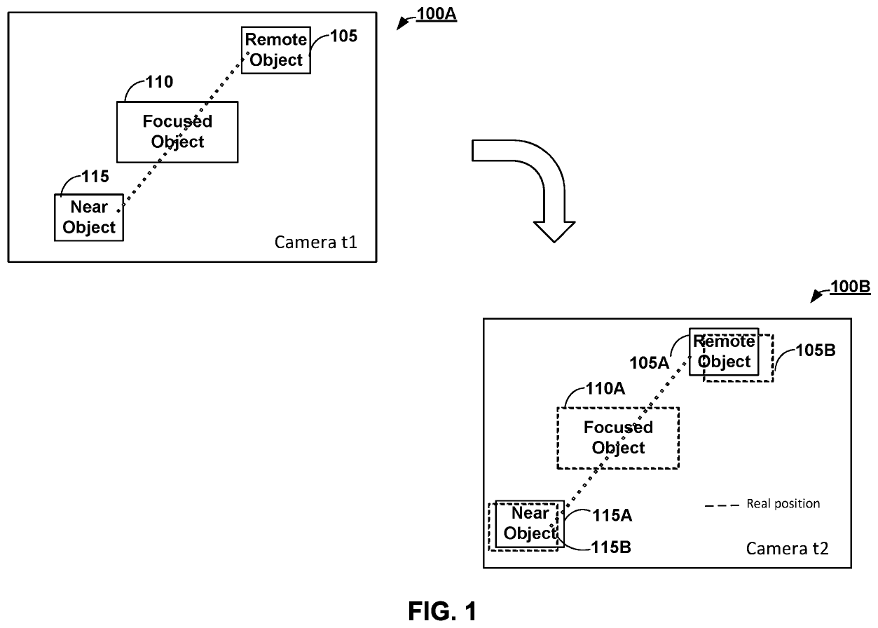

FIG. 1 illustrates binocular disparity in a multi-camera system, in accordance with example embodiments. For illustrative purposes, in FIG. 1, both cameras, t1 and t2, are facing the objects (focused and unfocused). In some situations, camera t2 may be physically installed adjacent to camera t1 (e.g., to the right, to the left, and so forth). For example, the camera positions may be designed to mimic a human left eye/right eye vision. Generally, focused scene objects with the same depth (i.e., distance to the camera), such as focused object 110, can be warped nearly perfectly from one camera, t1, to another camera, t2. For example, focused object 110 in camera t1 is warped to focused object 110A of camera t2, with no discrepancies. A planar object with a plane perpendicular to a viewing direction of the camera may exhibit such properties. Zooming in and/or out triggers a camera switch (e.g., between wide and ultra-wide, wide and tele, etc.), leading to a change in the FOV and a view discrepancy known as binocular disparity. For objects that are out of focus, a disparity (jump) between the images in two cameras is perceptible. For example, remote object 105 and near object 115 are out of focus in camera t1. Accordingly, when the cameras are switched, remote object 105 in camera t1 maps to remote object 105A in camera t2, which is displaced from a real position 105B. Similarly, near object 115 in camera t1 maps to near object 115A in camera t2, which is displaced from a real position 115B.

As described herein, a warping transformation may be applied to reduce the binocular disparity by warping the image from one camera to the other camera. Focused scene objects (e.g., focused object 110) with the same depth can be warped from one camera to another without perceptible disparities.

Warping discrepancies may occur for out of focus objects (e.g., remote object 105, near object 115, etc.), or a warping distortion may occur for the planes across multiple depths. Such discrepancies for out of focus objects depend on a depth and a baseline for the camera. For example, a focused planar object with a plane tilted to the viewing direction of the camera, there may be some “rotational” type discrepancies.

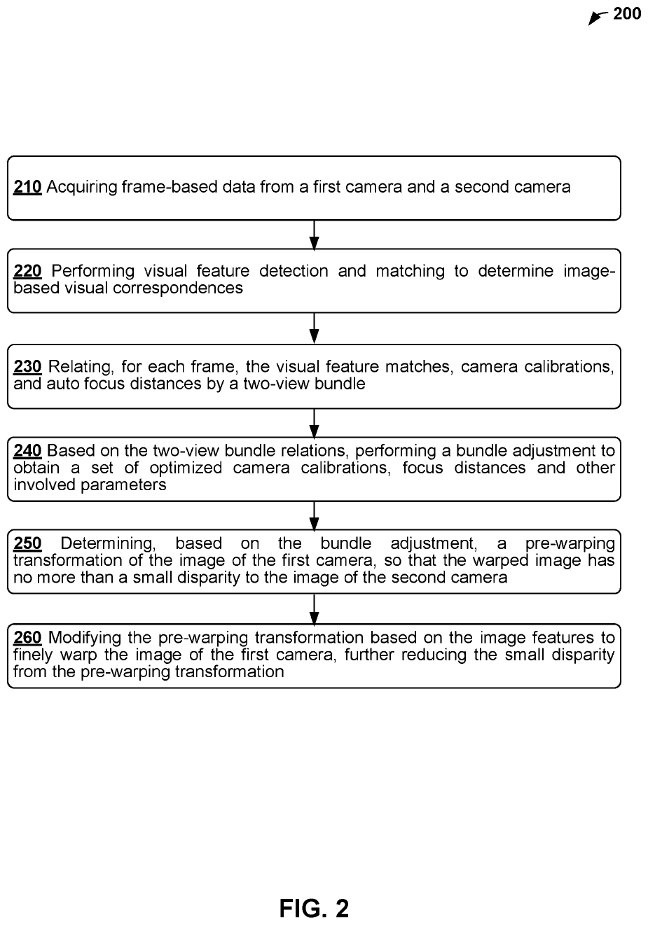

FIG. 2 is a flowchart of a workflow 200 for an image-based computation of a warping transformation, in accordance with example embodiments.

At block 210, the workflow involves acquiring frame-based data from a first camera and a second camera. A frame can be regarded as a unit of data processing. It includes input data required by the image-based continuous zooming, including the images, pre-crops of the images, camera calibrations including the intrinsics and extrinsics, auto-focus distances, and other metadata.

At block 220, the workflow involves performing visual feature detection and matching to determine visual correspondences. A variety of visual feature detectors and descriptors may be used, such as for example, the Scale-Invariant Feature Transform (SIFT), Speeded Up Robust Features (SURF), Fast REtinA Keypoint (FREAK), or the Features from Accelerated Segment Test (FAST) corner detection algorithm, and so forth. Additional and/or alternative visual features can be used in the pipeline, as long as the algorithm achieves visual correspondences of sufficient quality.

Image feature matching may be performed in two steps, such as feature extraction, and feature matching. Various feature extraction and matching approaches may be used. For the purposes herein, existing feature matching methods, such as ArCore features, or ILK features, may be used. The term “ILK” as used herein, generally refers to an inverse search version of the Lucas-Kanade algorithm for optical flow estimation.

At block 230, the workflow involves relating, for each frame, the visual feature matches, camera calibrations, and auto focus distances by a two-view bundle. Camera calibrations may be used to estimate the depths of the points observed as feature matches. As described herein, the OIS/VCM system and/or thermal effects may cause the geometric metadata, such as camera calibrations and focus distances, to be updated frame-by-frame with significant errors. Accordingly, manipulation of specific calibration parameters may be performed to make most points have their depth values close to the geometric focus distances.

Some embodiments may enable a smooth transition between cameras (e.g., Wide and Tele cameras), but result in an FOV jitter issue on a warping source camera. For example, visual features from downsized images (e.g., 320×240) may not correspond to the same landmarks frame-by-frame. Also, for example, the camera calibration is updated per-frame due to the OIS/VCM updates, and the scene focus depth is computed and/or corrected per-frame from the valid (e.g., inlier) feature matches between the dual cameras (e.g., Wide and Tele). In some embodiments, in the event that two cameras have different FOVs, the number of inlier visual feature matches may be limited by the smaller FOV (e.g., Tele), resulting in a waste of the visual information from the margins of the larger FOV camera (e.g., Wide).

Some approaches to reducing such jitter may involve the damping control of scene focus distance changes, and image-based ContiZoom may then be triggered during the zooming process. To further resolve the jitter issue and use as much visual information as provided by the larger-FOV camera, visual feature matching may be performed temporally between the neighboring frame t−1 and frame t, with the purpose of temporal consistency, so that each frame takes into account the geometric metadata of previous frames when determining a warping mesh.

At block 240, the workflow involves, based on the two-view bundle relations, performing a bundle adjustment to obtain a set of optimized camera calibrations, focus distances and other involved parameters. For example, image-based visual information may be effectively used to correct the geometric metadata from upstream modules, so that they are more compatible with the images to be displayed as continuous zooming previews.

In the event the bundle adjustment is performed frame-by-frame, respective per frame optimized solutions (e.g., with minimum reprojection pixel errors) for camera calibrations and focus distances may be independently determined. In some embodiments, a misalignment may exist across frames, resulting in a shaking preview if the warped frames are displayed in sequential playback.

In such embodiments, the geometric bundle may be built across a window of frames, and the optimization of camera calibrations and other metadata may not always result in a smooth change under the warping transformation. Accordingly, instead of applying the homography of most recently optimized data to warp the images, a damping process given by:

$${H}_{t} = ( 1 - λ ) * {H}_{t - 1} + λ * {I}_{t} \qquad ( Eqn . 1 )$$

is introduced for a gradual change and smooth change of the warping transformation. In Eqn. 1, the term λ is a damping ratio with values between 0 and 1, Hₜ is the homography to be applied to the frame t, and Iₜ is the optimized image-based homography at frame t.

In some embodiments, prior to extracting the image-based visual features, a homography G is determined based on the geometric metadata (e.g., camera calibrations and focus distances) from upstream modules. However, this may include errors from OIS/VCM update, thermal effect and other sources, as described previously. This may be corrected using image-based data as follows:

Generally, two sets of camera calibration models are available. One calibration model has been updated by OIS/VCM correction which directly corresponds to the visual features from the images, and the other calibration model is kept in a neutral state and used as the smooth initial values for further geometric optimizations.

The previously computed geometry-based homography G may be used to perform a coarse-level pre-warping of the image features and the associated calibrations, followed by the previously described image-based process to correct the remaining errors. Such an approach effectively combines the geometric and visual information to solve the technical problem.

At block 250, the workflow involves determining, based on the bundle adjustment, a pre-warping transformation of the image of the first camera, so that the warped image has no more than a small disparity to the image of the second camera.

Subsequently, at block 260, the workflow involves modifying the pre-warping transformation based on the image features to finely warp the image of the first camera, further reducing the small disparity from the pre-warping transformation.

Some embodiments involve optimizing the detecting of the one or more visual features and the generating of the visual correspondence by performing asynchronous multi-thread processing comprising receiving one or more images and associated metadata as inputs, and sending visual feature matches and associated metadata as outputs. For example, image-based continuous zooming may involve computationally resource intensive steps, such as visual feature detection and matching. To enable the solution to run in real-time (e.g., at least 30 frames per second (fps)) at a consumer-grade device, the computationally resource intensive steps may be asynchronously processed by a specific thread, which receives images and the associated metadata as inputs, and sends visual feature matches and the associated metadata as outputs.

The term “sparse features” as used herein, generally refers to the features detected that are scattered sparsely over an entire image. A feature point can be detected when a pixel and its vicinity meet a detection threshold. This may include, for example, the ArCore feature, portrait mode feature, and AutoCal feature.

The term “dense features” as used herein, generally refers to the feature detected that could cover an entire image, and a feature point may be detected based on a predefined image patch, and a matching may be found for each patch. In some embodiments, ILK can be used for dense feature detection. For example, an TLK algorithm may be used to extract “dense” feature points and matches from images.

The dense or sparse features may generally have different designs in the ContiZoom pipeline, as described in further detail below.

### Recalibration (Sparse Feature Flow)

As opposed to planar target features typically used during factory calibration, calibration of sparse features uses natural features to recalibrate the geometric information received from the camera sensors. For example, image features are used to update the geometric metadata, and the existing geometric-based computation is leveraged to compute the modified homography.

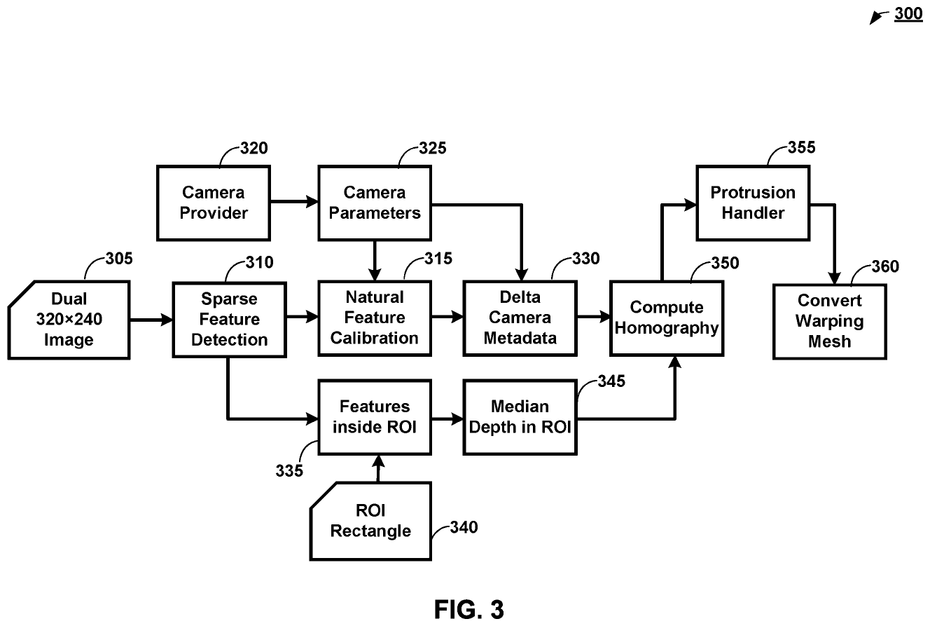

FIG. 3 is an example sparse feature workflow 300 for smooth continuous zooming in a multi-camera system, in accordance with example embodiments. The general flow with sparse features is illustrated.

At block 305, input images including dual 320×240 images are received. The input images are from the two target cameras. In some examples, the image resolution may range up to 640×480. The quality of feature matches depend more on the quality of a texture of the scene.

At block 310, sparse feature detection may be performed, as previously described. In some embodiments, an ArCore feature may be used. In some embodiments, the FAST feature may be used. Generally, scale invariant features are not needed as the dual image can be rescaled to provide the focal length relatively accurately.

Natural feature calibration may be performed at block 315. This process recalibrates the camera parameters 325 from a factory calibration, for example, provided by a camera provider 320. In some embodiments, a DualCameraCalibrator or AutoCal, each based on the FAST feature detector, may be used. Also, for example, an optical flow based detector such as ILK may be used. However, natural feature calibration is generally different from the factory calibration, since the natural features are not from planar objects. Accordingly, a bundle adjustment (BA)-based approach (e.g., block 240 of FIG. 2) may be preferable to perform natural feature calibration.

In some embodiments, the natural feature calibration may not optimize all the parameters, and may instead focus on “principal points” and “extrinsic rotation” for Wide and Tele. The following table, Table 1, summarizes the parameters that may need to be optimized. Table 1 is for illustrative purposes only, and may vary from device to device, and may be based on the types and/or characteristics of the cameras involved in the transition process.

TABLE 1

| | Wide | Tele | Ultra Wide |
|---|---|---|---|
| Principal Points | Yes | Yes | No |
| Skew | No | No | No |
| Focal Length | Maybe | Maybe | No |
| Translation | No | Maybe | No |
| Rotation | No | Yes | No |

At block 330, delta camera metadata may be obtained. CPI-based calibrations are with respect to an active array coordinate, whereas image-based algorithms require calibrations with respect to image coordinates. Accordingly, a transformation may be determined between the active array and the image. After the camera metadata is corrected, the difference between the factory calibrations and the corrected metadata may be stored as delta metadata, and may be saved separately from the CPI calibration metadata. In some embodiments, the delta may be a constant offset during a transition period from one camera to another.

In image-based correction, the same structure of camera metadata, which are the delta between the CPI outputs and the re-calibrated camera metadata, may be used. In some embodiments, the delta focusing distance (e.g., depth) may be used.

At block 335, features inside a Region of Interest (ROI) may be detected. An ROI, as used herein, is a subregion in an image frame that is considered to be significant to a user, and is used in camera applications as a pilot region for many features, such as auto-focusing, which provides the focusing distance that is used for geometry-based methods. In some embodiments, the ROI may be obtained as ROI rectangle 340 from an algorithm such as a face detection algorithm, a saliency detection algorithm, and so forth. Generally, ROI may be processed differently for sparse features and dense features. Features inside the ROI may be based on the sparse features detected at block 310.

A median depth in the ROI is determined at block 345. For example, a median of the depths of (inlier) image feature points, extracted by the methods of sparse/dense features as described above, may be determined.

### Temporal Feature Matching and Tracking

In some embodiments, temporal feature matching and tracking may be performed. Generally speaking, the same landmark or ROI can appear in a plurality of frames (e.g., three or more frames), resulting in feature tracks. In some embodiments, temporal feature tracking may be applied only to the larger-FOV (e.g., Wide) camera, sufficient for the temporal consistency of ContiZoom meshes.

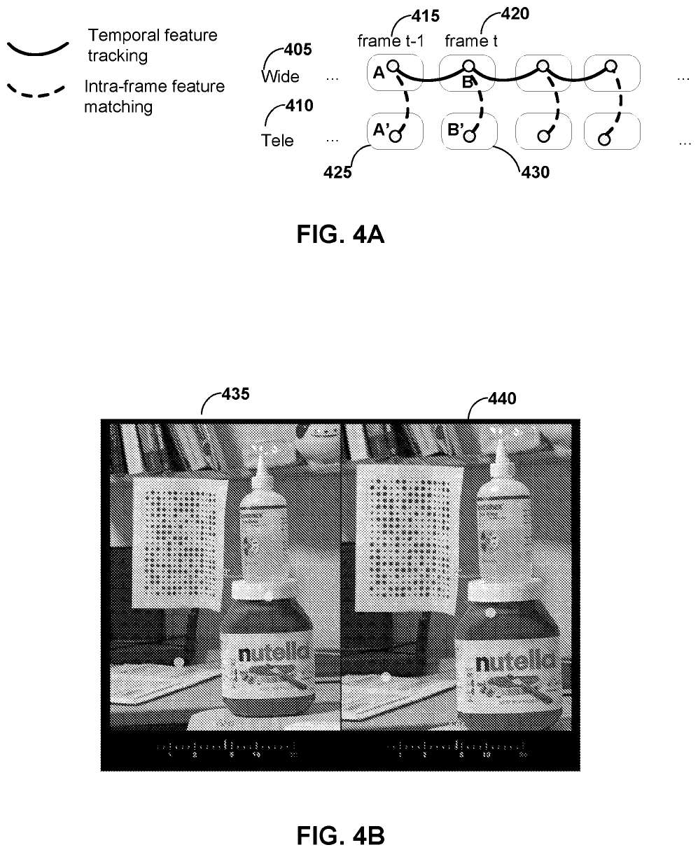

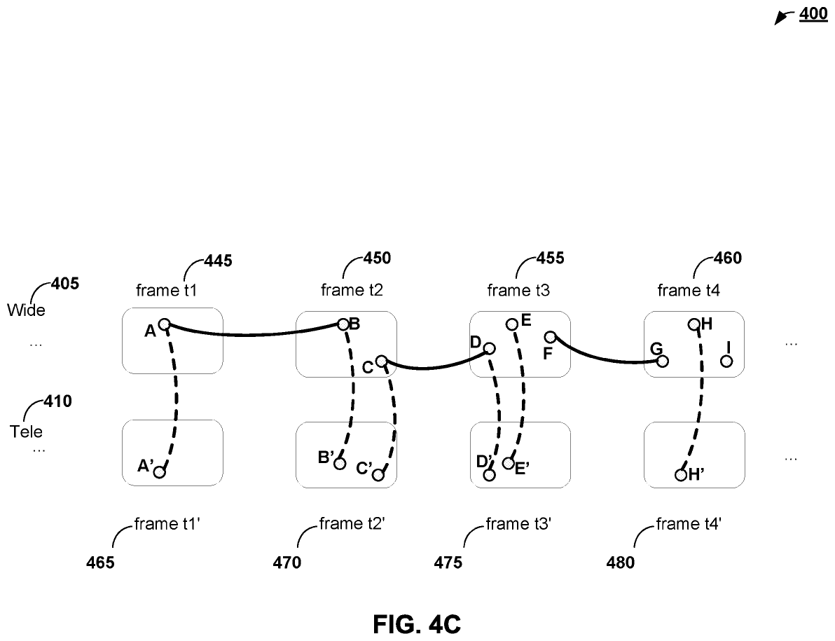

FIG. 4A illustrates temporal feature matching and tracking, in accordance with example embodiments. Referring to FIG. 4A, a plurality of successive frames are illustrated for a wide camera 405 and a telephoto camera 410. For wide camera 405, first frame 415 at time t−1 is illustrated and a second frame 420 at time t is illustrated as two consecutive frames. For telephoto camera 410, third frame 425 at time t−1 is illustrated and a fourth frame 430 at time t is illustrated as two consecutive frames. Intra-frame feature matching is illustrated where at time t−1, first feature A in first frame 415 is matched to a corresponding feature A′ in third frame 425. Similarly, intra-frame feature matching is illustrated where at time t, second feature B in second frame 420 is matched to a corresponding feature B′ in fourth frame 430. Temporal feature matching and tracking is illustrated where first feature A in first frame 415 at time t−1 is matched to second feature B in second frame 420 at time t. For illustrative purposes, temporal feature tracking is shown for wide camera 405. Generally, it may be desirable to perform temporal feature tracking in the camera with a larger FOV so as to capture the relevant feature tracks.

FIG. 4B illustrates example images for temporal feature matching and tracking, in accordance with example embodiments. Referring to FIG. 4B, two images are illustrated. First image 435 illustrates feature matching without damping of focus distance. Second image 440 illustrates temporal feature matching to reduce jitter.

Generally, temporal feature matching and tracking may involve two tasks: 1) determining temporal feature tracking information from the images; and 2) applying temporal feature tracking to the existing pipeline to improve ContiZoom quality.

In some embodiments, the first task may involve providing interface functions of feature extraction and feature matching respectively. As described with respect to FIG. 4A, intra-frame feature matching may be performed on the dual images of lead and follower cameras (e.g., wide camera 405 to telephoto camera 410) to build intra-frame feature matches. In some embodiments, temporal feature tracking may be performed by enabling feature matching between neighboring frames t−1 and t, with a refactoring of the interface functions and the cache of the extracted features from the previous frame.

In some embodiments, the second task may involve building an indexing manager to handle the indices of visual feature points and matches among multiple images. This indexing manager facilitates utilization of temporal feature tracks along with the intra-frame feature matches. For example, the indexing manager manages the indices of visual features, including the index of feature points and the index of feature matches, along with their mutual correspondences. In some embodiments, it may support the query of feature point index from feature match index, and the query of feature match index from the index of a first feature point and a second feature point of this match.

Some embodiments may involve one or more maps. For example, a first map from the index of a feature point from a first image to the index of the match pair involving the feature point. As another example, a second map from the index of a feature point from a second image to the index of the match pair involving the feature point. Also, for example, a vector of feature matches may be determined. For example, each feature match may involve two feature points from the first image and the second image respectively.

Experimental evidence indicates that the jitters on Wide-as-lead camera may be primarily caused by a jitter of the per-frame estimated scene focus distance. Accordingly, temporal feature tracks may be used to estimate the scene focus distance at frame t. Utilizing feature tracks across multiple frames enables quality improvement under temporal consistency.

In some situations, it may be reasonable to assume that when a user performs a zooming in and/or out operation with the camera, the user the user is likely not to have large movements (e.g., panning, running, walking, or rapid changes of salient objects/ROIs). In the event that the user has large movements, small jitters or FOV transitions of the zooming are unlikely to be conspicuous. In the event that the user does not have large movements, the change of scene focus distance between neighboring frame t−1 and t needs to be managed to avoid perceptible jitter. One approach to achieve this is to keep the scene focus distance unchanged if frame t−1 and frame t have a sufficient number of inlier matches.

FIG. 4C illustrates an example application 400 of temporal feature matching and tracking, in accordance with example embodiments. FIG. 4C illustrates a plurality of successive frames for a wide camera 405 and a telephoto camera 410. Generally, each frame may estimate a scene depth from a set of feature matches between the two cameras (e.g., wide camera 405 and telephoto camera 410) of this same frame. In some embodiments, an inlier feature may be selected to represent the scene for depth estimation. For illustrative purposes, the example presented involves four (4) scene focus distances, namely, d1, d2, d3, and d4. Temporal feature tracking between frame t−1 and frame t may be performed as follows.

In the event that a selected inlier feature has a temporally matched counterpart, then the scene focus distance d2 may be set to be the same as d1. For example, feature A in frame t1 445 has a corresponding feature A′ in frame t1′ 465. Also, feature A in frame t1 445 has a temporally matched counterpart feature B in frame t2 450. Accordingly, the scene focus distance d2 may be set to be the same as d1.

In the event that a selected inlier feature does not have a temporal match, but another feature with a similar depth as that initially selected inlier has a temporal match and an intra-frame feature match, then the scene focus distance d3 may be set to be the same as d1. For example, feature E in frame t3 455 does not have a temporal match. However, feature D in frame t3 455 is at a similar depth as feature E in frame t3 455. Also, feature D in frame t3 455 has a temporally matched counterpart feature C in frame t2 450. Furthermore, feature D in frame t3 455 has a corresponding feature D′ in frame t3′ 475. Accordingly, the scene focus distance d3 may be set to be the same as d1.

In the event that a selected inlier feature and its siblings with close depths do not have both a temporal match and an intra-frame feature match, then d4 is recomputed. For example, feature H in frame t4 460 has a corresponding feature H′ in frame t4′ 480. However, feature H in frame t4 460 is not temporally matched to another feature. Features G and I in frame t4 460 appear as features with a similar depth as feature F. Feature G is temporally matched to feature F in frame t3 455; however, feature G does not have an intra-frame feature match. Feature I also does not have an intra-frame feature match or a temporal match. Accordingly, d4 is recomputed.

In the approach described above, the estimation of the scene depth (i.e., focus distance) is based on a per-frame intra-frame (i.e., inter-camera) feature matches, and temporal tracking is generally used as a post-verification to determine whether to change the scene focus distances in a succeeding frame. However, this approach does not effectively use the information from temporal feature tracking.

Accordingly, an alternate approach to reducing and/or removing jitter by adjusting the scene focus distances may involve a direct use of temporal feature tracking information, especially when such information is available with a sufficiently high quality. Factors that may determine a quality of the temporal feature tracking information may include one or more of (1) a sufficient number of temporal matches between neighboring frames at time t−1 and at time t; (2)) a sufficient number of temporal matches that can compose temporal tracking across multiple frames in the absence of a big panning and/or rotation motion; or (3) an affordable power and latency when running on a mobile device.

In one approach, temporal feature tracking along with gyroscopic measurements may be used to triangulate and select the “up-to-scale” 3D points as good inlier landmarks. Subsequently, the dual camera observations of these inlier landmarks may be used to estimate the per-frame scene depths.

In another approach, temporal feature tracking along with gyroscopic and accelerometer measurements may be used to directly estimate device poses and the 3D points as inlier landmarks. The per-frame scene depths may then be based on these inlier landmarks. In view of the power and latency aspects of the device pose estimation, this approach may be more applicable to offline processing.

Referring again to FIG. 3, the delta camera metadata from block 330 and the median depth from block 345 is used at block 350 to update the geometric homography (to determine an updated warping transformation) based on image features. For example, matched feature points may be used to remedy inaccurate geometric metadata. This may involve two approaches, a recalibration-based sparse feature flow approach, and an image-homography-based dense feature flow approach.

Homography H is a 3×3 matrix that maps pixels in a plane in a first coordinate system for a first camera to corresponding pixels at the same plane in a second coordinate system for a second camera. The homography may be decomposed as follows:

$$H = {K}_{2} \cdot ( R - t * \frac{{n}^{T}}{d} ) \cdot {K}_{1}^{- 1} \qquad ( Eqn . 2 )$$

where K₁ and K₂ are intrinsic matrices corresponding to the first camera and the second camera, respectively, containing focal lengths and principal points, and where [R_{3×3}|t_{3×1}] is the extrinsic that can transform a point in the first coordinate system for the first camera to the second coordinate system for the second camera, d and n define the focused plane for this homography in the coordinate of the first camera, such that the points X in the plane satisfy n^{T}X+d=0. In general, n=[0, 0, −1]T is used.

Given camera calibrations and object distance in focus, there are at least two ways to determine the homography. For example, in a first approach, a homography can be determined by inputting these parameters into the formula as displayed in Eqn. 2. Also, for example, in a second approach, a homography can be determined from a set of pixel-pairs (e.g., at least 4 sample point pairs). For example, the homography matrix transforms a plane (of a certain depth) on the tele camera to a corresponding plane on the wide camera. In some embodiments, for a pair of cameras (e.g., Tele and Wide camera models), a “four point” approach may be used to compute the homography matrix between Tele and Wide cameras. The input may include the Tele and Wide camera model (intrinsic, and extrinsic), and the target plane distance to the Tele (object distance) camera.

The “four point” approach may involve arbitrarily selecting four two-dimensional (2D) points on the Tele camera, denoted as Pₜₑₗₑ. Next, the 2D points may be unprojected by using camera intrinsic parameters as 3D rays, denoted as Ray. Subsequently, Ray may be intersected with the given plane, which is at a distance, Obj_dist, away from the Tele camera. This generates four three-dimensional (3D) points in the real space. The 3D points may be projected onto the Wide camera, to obtain P_{wide}. The homography matrix may then me determined as:

$$[ {P}_{w i d e} \vert 1 ] = [ H * {P}_{tele} \vert 1 ] \qquad ( Eqn . 3 )$$

where [P|1] represents the homogeneous coordinate of P.

The second approach for determining the homography, from the set of pixel-pairs, can involve distortions of camera intrinsics in the estimation process. If image-based visual information is not available, then the camera calibrations are from the CPI library, and focus distances are from the autofocus process.

At block 355, a protrusion handler performs protrusion handling based on the homography from block 350.

At block 360, a mesh conversion function is applied.

### Image-based Homography (Dense Feature Flow)

The image-based approach directly computes an updated homography based on matched image features, and combines the image-based homography with the geometric-based homography. Since the goal is to warp two images (from two cameras) together, the image features can be directly used to compute the warping homography, without the geometric camera metadata.

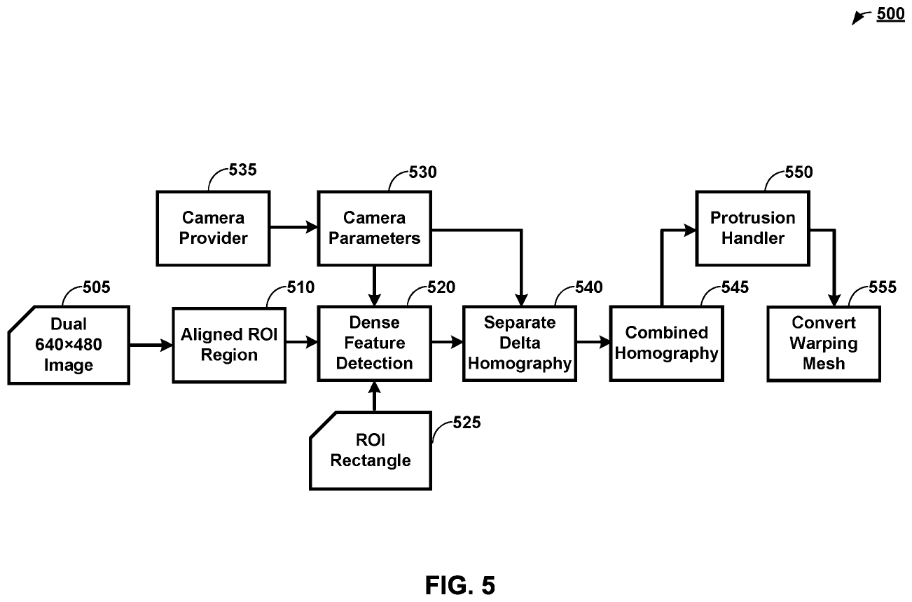

FIG. 5 is an example dense feature workflow 500 for smooth continuous zooming in a multi-camera system, in accordance with example embodiments. The general flow with dense features is illustrated.

At block 505, input image including dual 320×240 images are received. The input images are from the two target cameras. In some examples, the image resolution may be 640×480 or larger, depending on a computing power of the computing device, and a latency requirement for various use cases. The quality of feature matches may depend more on the quality of a texture of the scene.

Aligned ROI Region is computed at block 510. Some embodiments may involve cropping the original image frame to the ROI region. An ROI rectangle 525 may be obtained (e.g., as previously described with reference ROI rectangle 340). Some embodiments involve aligning the two ROI regions with the computed geometry-based homography, so that the dense feature detection may have a better initial placement. To save computational resources, in some embodiments, the translational components may be extracted from the geometry-based homography, and these translational components may be applied to the ROI. In some embodiments, this translation may be performed through cropping.

Dense feature detection may be performed at block 520. Such feature detection/matching has been described previously, and the TLK algorithm may be used. This process recalibrates the camera parameters 530 from a factory calibration, for example, provided by a camera provider 535. In some embodiments, a DualCameraCalibrator or AutoCal, each based on the FAST feature detector, may be used. Also, for example, an optical flow based detector such as TLK may be used. However, natural feature calibration is generally different from the factory calibration, since the natural features are not from planar objects. Accordingly, a bundle adjustment (BA)-based approach (e.g., block 240 of FIG. 2) may be preferable to perform natural feature calibration.

At block 540, a separate delta homography may be determined. In some embodiments, this may be based on camera parameters 530 from a factory calibration, for example, provided by a camera provider 535. In some embodiments, the dense features from the foreground may be separated from those in the background. For example, even though feature detection may focus on features inside the ROI, background features may also be used. In some embodiments, a translation-only homography may be applied to confirm that the homography plane will be perpendicular to the z-axis of the camera. Also, for example, a two cluster k-means may be used, with the features being the disparity, and the feature positions selected to be the center of ROI.

A similar k-means process may be used for the counterpart process of the sparse feature flow, however, the sparse feature may not have enough feature points to apply these approaches. Accordingly, a less optimal solution based on determining the median depth may be used for the sparse feature flow (e.g., at block 345).

Generally, the foreground homography is a delta homography on top of the geometry-based homography, since the original ROI has already been shifted using the geometry-based homography.

At block 545, an updated warping transformation (or combined homography) may be determined as a combination of the image-based delta homography and the geometry-based homography. In some embodiments, the updated warping transformation is a concatenation of the two homography maps (image-based homography as applied after the geometry-based homography), with appropriate coordinate transformations.

For both the dense feature flow and the sparse feature flow, existing components may be leveraged. For example, the term “camera provider” (e.g., camera provider 320, camera provider 535) refers to the module that reads in the factory calibration file and uses CPI to generate a camera parameter that corresponds to each OIS/VCM metadata.

The term “CPI Camera Parameter” (e.g., camera parameters 325, camera parameters 530) refers to camera intrinsic and/or extrinsic parameters computed by CPI.

At block 550, a protrusion handler performs protrusion handling based on the combined homography from block 545.

At block 555, a mesh conversion function is applied.

The sparse features may be generally more accurate, and provide feature points with precise (x. y) image coordinates. However, the sparse feature may be relatively slow, and the detected feature number may depend on a scene complexity. Accordingly, in an absence of a sufficient number of feature detections, performance of the calibration optimization may be negatively impacted.

The dense features may be less accurate, as these “feature points” are essentially image patches. However, dense feature detection is generally fast, and less dependent on the scene complexity.

In some embodiments, a combination of sparse and dense features may be used.

For example, sparse features may be detected first, and in the event that the number of detected features is below a threshold, dense feature detection may be performed.

Also, for example, sparse features may be used to determine more accurate depth, and a better homography may be determined as an initial guess for a dense feature match.

As another example, dense features may be used to determine a regional patch of foreground objects, and sparse features may be used to detect accurate feature points on the foreground region patch.

For both the sparse and dense features, delta data is saved. In the case of sparse features, the delta data is the camera metadata, and in the case of dense features, the delta data is the homography. Generally, during a zoom operation, both the cameras may not be available.

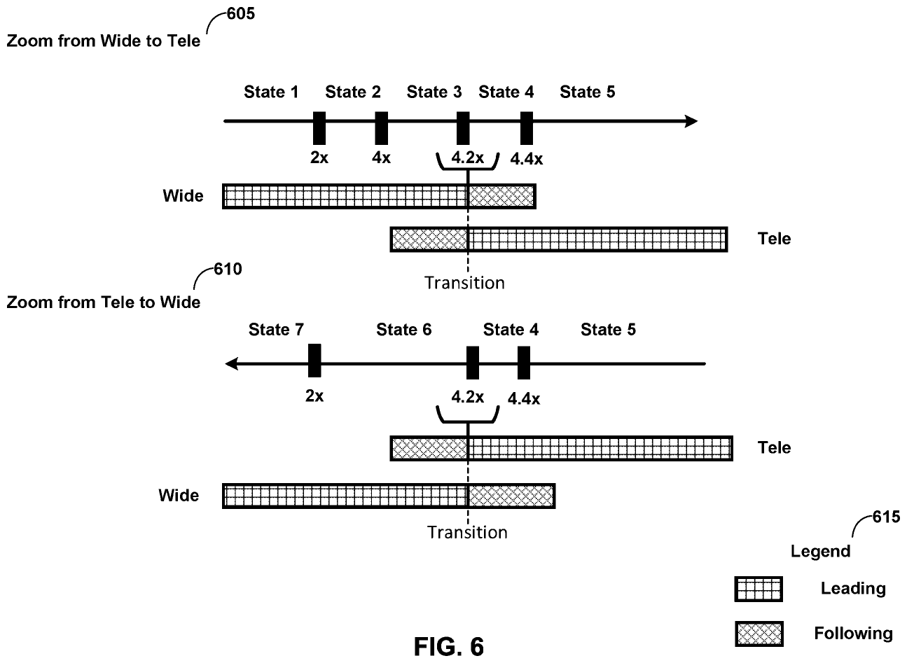

FIG. 6 illustrates example handling of delta data during camera transitions, in accordance with example embodiments. The example in FIG. 6 is based on a transition between Wide and Tele cameras. However, a similar approach may be applied to transitions between different pairs of cameras. The example zoom ratios, states, number of states, transition points, and so forth are for illustrative purposes only. Such values may be different depending on the device type, types of cameras, the distance of the camera from the objects, and so forth. For example, FIG. 6 uses “4.2×” to mark the zoom ratio where a transition between Wide and Tele cameras can occur. However, this value may be different depending on the device type, the cameras involved in the transition, the distance of the camera from the objects, and so forth. Also, for example, the zoom ratios (e.g., 2×, 4×, 4.2×, 4.4×) used in the example in FIG. 6 are example values and may vary depending on device and/or system configurations.

For example, a transition from Wide to Tele 605 and a reverse transition from Tele to Wide 610 is illustrated. The legend 615 indicates the leading camera and the following camera.

State 1 (initially open at 1.0×) corresponds to when the camera is first activated. The initial camera may be the wide camera, and the homography is the identity operation. The geometric data from CPI of the wide camera may be updated, since it will not affect the homography.

State 2 (from 2× scale) corresponds to when the homography gradually changes from the identity operation to a target homography. However, since the dual cameras are not available at State 2, this homography is geometry based, and does not take image features into consideration. There is no delta data. In order not to cause any visual distortions during the transition between State 1 and State 2, in some embodiments, the update from CPI may be damped.

State 3 (from 4.0× scale to 4.2× scale) corresponds to when the two cameras are simultaneously active. In this case, the wide camera is the primary or lead camera, and the tele camera is the secondary or following camera. The image-based approach described previously may be used to compute the delta data, and the updated metadata may be used to compute the homography.

State 4 (from 4.2× scale to 4.4× scale) corresponds to after the switch from the wide camera to the tele camera occurs. In this case, the tele camera is the primary or lead camera, but the wide camera will still be active. No warping is applied, and the homography will therefore be the identity operation. The last delta computed is stored. And, the geometric camera metadata of the tele and wide cameras will be updated.

In State 5 (beyond 4.4×), the tele camera is the primary or lead camera, and the wide camera will be inactive or closed. Other operations remain the same as in State 4.

State 6 (back to wide) is similar to State 2, however, delta data is now present. Accordingly, the delta data is stored, and the homography is computed with the additional delta.

State 7 (back to wide) is similar to State 1, however, delta data is now present. Accordingly, the delta data is stored.

During successive transitions, the process may repeat between States 3 to 7.

The transition zone is a zone defined in smooth transitioning, where the two cameras will be active simultaneously in a certain range of the zooming scale, so that metadata (such as from OIS/VCM) may be streamed in simultaneously for both the cameras. For the image-based approach described herein, it may be preferable to configure this transitioning period to be as large as possible, to reduce abrupt changes between camera metadata, and/or between image-based results and geometry-based results.

In some embodiments, hardware limitations may make it impractical to stream in two cameras all the time, and/or to enlarge the transition zone to a degree that may be optimal. In such embodiments, occasional dual streaming may be used. For example, occasional dual streaming means that the two cameras are occasionally active simultaneously, not based on the zooming scale, but based on a timer. For example, after a camera application is opened, the timer may be set to 10 seconds, and the two cameras may be simultaneously active every 10 s. Smooth continuous zooming may occur periodically based on such a timer.

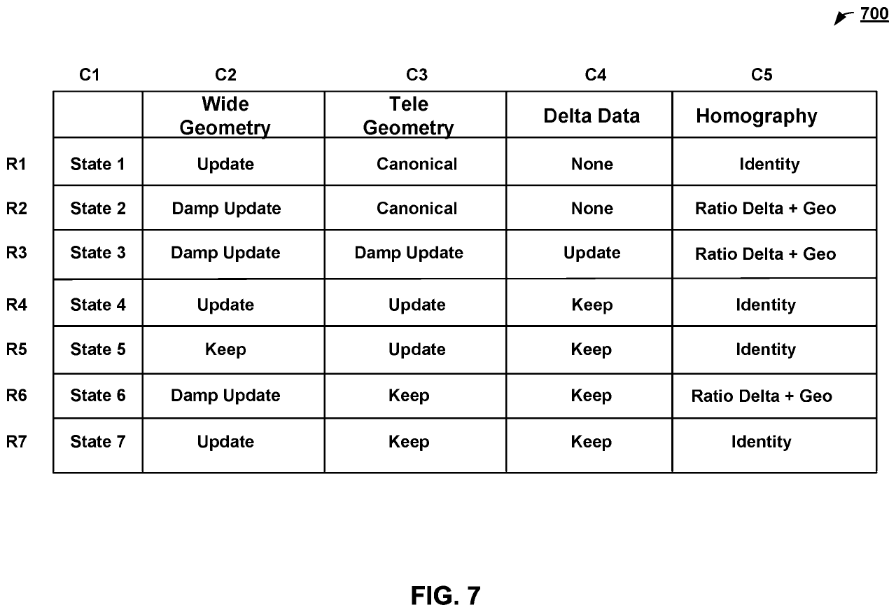

FIG. 7 is a table 700 illustrating various cases for switching between a tele camera and a wide angle camera, in accordance with example embodiments. Column C1 lists the states described with reference to FIG. 6; column C2 lists the status related to geometric metadata for the wide camera; column C3 lists the status related to geometric metadata for the tele camera; column C4 lists the status related to delta data; and column C5 lists the status related to the homography. Each row, Row R1-R7, provides the status for each state, States 1-7, respectively. Table 700 summarizes the information provided with reference to FIG. 6. For example, row R2 indicates that for State 2, a damp update is applied to the geometric metadata for the wide camera, that a canonical map is used for the geometric metadata for the tele camera, that there is no delta data, and that the homography is a combination of ratio delta and geometric homography. Other rows present similar information for the respective states.

The term “delta data” refers to the results of the image-based solution described previously, where the delta is camera geometric metadata for the sparse case, and the delta homography for the dense case.

The status “update” generally indicates a near real-time update according to the OIS/VCM. The status “keep” indicates that the status is the same as the previous state. The term “damp update” refers to a gradual update that will have a damping ratio between the data from a previous frame and data from a current frame. The term “geo” refers to geometry based homography (without image features). The term “delta+geo” refers to a combined homography of an image-based solution and a geometry-based solution. The term “ratio homography” indicates that a strength of the homography may depend on the zoom scale (e.g. for State 2 in row R2), that the homography strength is identity at 2.0×, and that the homography will be at full-strength when at the 4.2×. Other scales in between 2.0× and 4.2× may be determined as an interpolation between the identity operation and the full strength homography.

The damping for delta is generally an operation to smoothen a sharp change of the geometric data, such as abrupt changes of OIS/VCM. The damping ratio may be based on a change of the zooming scale between two successive frames. A similar damping may be applied for the delta.

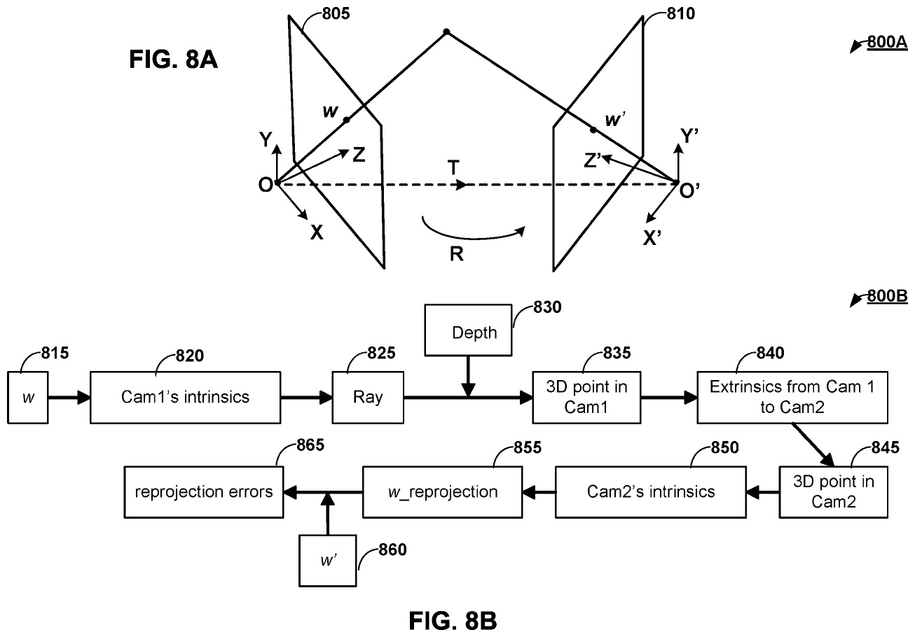

FIG. 8A depicts an example geometric relation 800A at each pair of matched pixels, in accordance with example embodiments. A first plane 805 in the XYZ-plane is shown to include a point, w, with coordinates with reference to an origin, O. Second plane 810 corresponds to first plane 805 in the X′Y′Z′-plane. The first coordinate system representing the XYZ-plane can be mapped to the second coordinate system representing the X′Y′Z′-plane with coordinates with reference to an origin, O′, by a map X′=RX+T, where R is a rotation, and T is a translation. For example, the point w in first plane 805 is mapped to the point w′ in second plane 810. In some embodiments, a two-view geometric relation can be established at each pair of matched pixels with camera intrinsics and extrinsics, triangulated points from visual matches, and auto-focus distance as an initial scene depth.

FIG. 8B depicts a workflow 800B to determine a geometric relation at each pair of matched pixels, in accordance with example embodiments. At block 815, a point w (e.g., in first plane 805) is selected. At block 820, intrinsics related to the first camera (e.g., the wide camera with reference to FIGS. 5 and 6) are determined. At block 825, the 2D point w may be unprojected as a 3D ray, denoted as Ray, by using the intrinsics related to the first camera. Depth data may be received at block 830. At block 835, based on Ray and the depth data, a 3D point is determined for the first camera. At block 840, extrinsics from the first camera are applied to the second camera (e.g., the tele camera with reference to FIGS. 5 and 6). At block 845, a 3D point for the second camera (corresponding to the 3D point determined at block 835) is determined. At block 850, intrinsics related to the second camera are determined. At block 855, a reprojection of point w is determined based on the intrinsics related to the second camera. Based on an actual position of point w′ in the second camera as obtained at block 860 and the reprojection of point w, one or more reprojection errors are determined at block 865.

Accordingly, a visual-based correction of geometric data at individual frames is provided. Workflow 800B enables minimized reprojection errors of the visual correspondences. Based on workflow 800B, the geometry-based homography may be re-estimated by the partially corrected camera calibrations and object distance in focus, to achieve smoothness across frames.

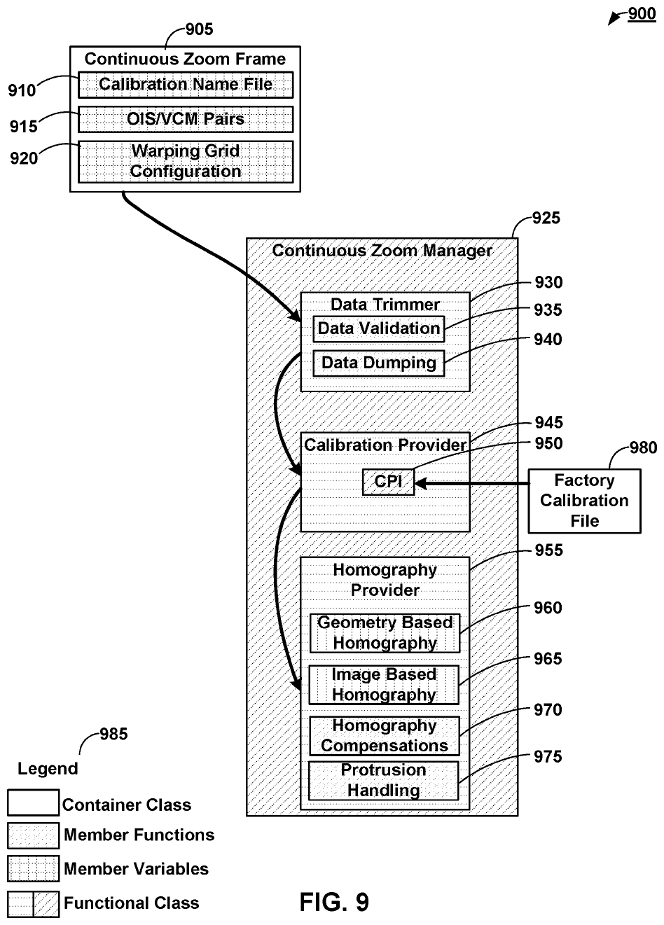

FIG. 9 depicts an example workflow 900 for smooth continuous zooming in a multi-camera system, in accordance with example embodiments. A continuous zoom frame 905 may include calibration name file 910, OIS/VCM pairs 915 from the two cameras, and warping grid configuration 920.

The algorithm described herein with reference to at least FIGS. 1-8 may be managed by continuous zoom manager 925. In some embodiments, continuous zoom manager 925 may include data trimmer 930, calibration provider 945, and homography provider 955. Data trimmer 930 may perform data validation 935 and data dumping 940. Calibration provider 945 may provide CPI parameters 950 as obtained from a factory calibration file 980.

Homography provider 955 may determine geometry based homography 960, and image based homography 965, as described herein. Homography provider 955 may then determine homography compensation 970, and protrusion handling 975.

Legend 985 indicates the various classes of components involved, such as container class, member functions, member variables, and the functional class.

### Example Data Network

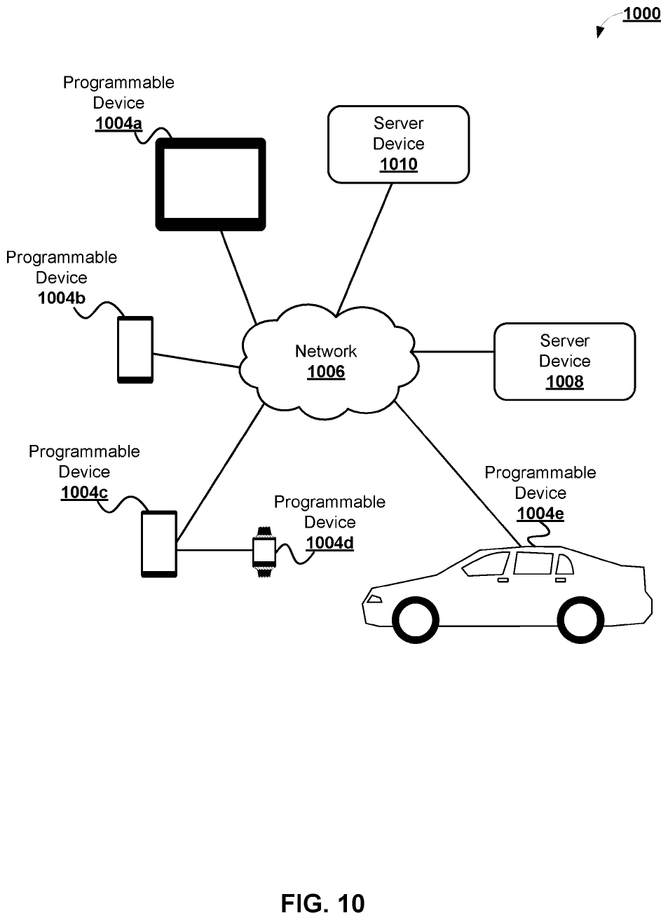

FIG. 10 depicts a distributed computing architecture 1000, in accordance with example embodiments. Distributed computing architecture 1000 includes server devices 1008, 1010 that are configured to communicate, via network 1006, with programmable devices 1004a, 1004b, 1004c, 1004d, 1004e. Network 1006 may correspond to a local area network (LAN), a wide area network (WAN), a WLAN, a WWAN, a corporate intranet, the public Internet, or any other type of network configured to provide a communications path between networked computing devices. Network 1006 may also correspond to a combination of one or more LANs, WANs, corporate intranets, and/or the public Internet.

Although FIG. 10 only shows five programmable devices, distributed application architectures may serve tens, hundreds, or thousands of programmable devices. Moreover, programmable devices 1004a, 1004b, 1004c, 1004d, 1004e (or any additional programmable devices) may be any sort of computing device, such as a mobile computing device, desktop computer, wearable computing device, head-mountable device (HMID), network terminal, a mobile computing device, and so on. In some examples, such as illustrated by programmable devices 1004a, 1004b, 1004c, 1004e, programmable devices can be directly connected to network 1006. In other examples, such as illustrated by programmable device 1004d, programmable devices can be indirectly connected to network 1006 via an associated computing device, such as programmable device 1004c. In this example, programmable device 1004c can act as an associated computing device to pass electronic communications between programmable device 1004d and network 1006. In other examples, such as illustrated by programmable device 1004e, a computing device can be part of and/or inside a vehicle, such as a car, a truck, a bus, a boat or ship, an airplane, etc. In other examples not shown in FIG. 10, a programmable device can be both directly and indirectly connected to network 1006.

Server devices 1008, 1010 can be configured to perform one or more services, as requested by programmable devices 1004a-1004e. For example, server device 1008 and/or 1010 can provide content to programmable devices 1004a-1004e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 1008 and/or 1010 can provide programmable devices 1004a-1004e with access to software for database, search, computation, graphical, audio, video, World Wide Web/Internet utilization, and/or other functions. Many other examples of server devices are possible as well.

### Computing Device Architecture

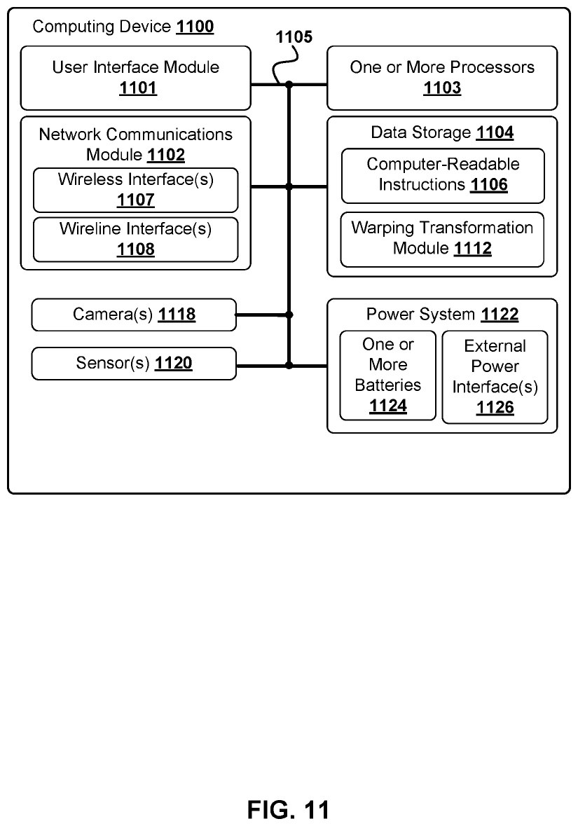

FIG. 11 is a block diagram of an example computing device 1100, in accordance with example embodiments. In particular, computing device 1100 shown in FIG. 11 can be configured to perform at least one function of and/or related to method 1200.

Computing device 1100 may include a user interface module 1101, a network communications module 1102, one or more processors 1103, data storage 1104, one or more cameras 1118, one or more sensors 1120, and power system 1122, all of which may be linked together via a system bus, network, or other connection mechanism 1105.

User interface module 1101 can be operable to send data to and/or receive data from external user input/output devices. For example, user interface module 1101 can be configured to send and/or receive data to and/or from user input devices such as a touch screen, a computer mouse, a keyboard, a keypad, a touch pad, a trackball, a joystick, a voice recognition module, and/or other similar devices. User interface module 1101 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1101 can also be configured to generate audible outputs, with devices such as a speaker, speaker jack, audio output port, audio output device, earphones, and/or other similar devices. User interface module 1101 can further be configured with one or more haptic devices that can generate haptic outputs, such as vibrations and/or other outputs detectable by touch and/or physical contact with computing device 1100. In some examples, user interface module 1101 can be used to provide a graphical user interface (GUI) for utilizing computing device 1100.

Network communications module 1102 can include one or more devices that provide one or more wireless interfaces 1107 and/or one or more wireline interfaces 1108 that are configurable to communicate via a network. One or more wireless interfaces 1107 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. One or more wireline interfaces 1108 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1102 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1103 can include one or more general purpose processors, and/or one or more special purpose processors (e.g., digital signal processors, tensor processing units (TPUs), graphics processing units (GPUs), application specific integrated circuits, etc.). One or more processors 1103 can be configured to execute computer-readable instructions 1106 that are contained in data storage 1104 and/or other instructions as described herein.

Data storage 1104 can include one or more non-transitory computer-readable storage media that can be read and/or accessed by at least one of one or more processors 1103. The one or more computer-readable storage media can include volatile and/or non-volatile storage components, such as optical, magnetic, organic or other memory or disc storage, which can be integrated in whole or in part with at least one of one or more processors 1103. In some examples, data storage 1104 can be implemented using a single physical device (e.g., one optical, magnetic, organic or other memory or disc storage unit), while in other examples, data storage 1104 can be implemented using two or more physical devices.

Data storage 1104 can include computer-readable instructions 1106 and perhaps additional data. In some examples, data storage 1104 can include storage required to perform at least part of the herein-described methods, scenarios, and techniques and/or at least part of the functionality of the herein-described devices and networks. In some examples, data storage 1104 can include storage for a warping transformation module 1112 (e.g., a module that computes the geometry-based homography, the image-based homography, and so forth). In particular of these examples, computer-readable instructions 1106 can include instructions that, when executed by one or more processors 1103, enable computing device 1100 to provide for some or all of the functionality of warping transformation module 1112.

In some examples, computing device 1100 can include one or more cameras 1118. Camera(s) 1118 can include one or more image capture devices, such as still and/or video cameras, equipped to capture light and record the captured light in one or more images; that is, camera(s) 1118 can generate image(s) of captured light. The one or more images can be one or more still images and/or one or more images utilized in video imagery. Camera(s) 1118 can capture light and/or electromagnetic radiation emitted as visible light, infrared radiation, ultraviolet light, and/or as one or more other frequencies of light. Camera(s) 1118 can include a wide camera, a tele camera, an ultrawide camera, and so forth. Also, for example, camera(s) 1118 can be front-facing or rear-facing cameras with reference to computing device 1100.

In some examples, computing device 1100 can include one or more sensors 1120. Sensors 1120 can be configured to measure conditions within computing device 1100 and/or conditions in an environment of computing device 1100 and provide data about these conditions. For example, sensors 1120 can include one or more of: (i) sensors for obtaining data about computing device 1100, such as, but not limited to, a thermometer for measuring a temperature of computing device 1100, a battery sensor for measuring power of one or more batteries of power system 1122, and/or other sensors measuring conditions of computing device 1100; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1100, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1100, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1100, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1120 are possible as well.

Power system 1122 can include one or more batteries 1124 and/or one or more external power interfaces 1126 for providing electrical power to computing device 1100. Each battery of the one or more batteries 1124 can, when electrically coupled to the computing device 1100, act as a source of stored electrical power for computing device 1100. One or more batteries 1124 of power system 1122 can be configured to be portable. Some or all of one or more batteries 1124 can be readily removable from computing device 1100. In other examples, some or all of one or more batteries 1124 can be internal to computing device 1100, and so may not be readily removable from computing device 1100. Some or all of one or more batteries 1124 can be rechargeable. For example, a rechargeable battery can be recharged via a wired connection between the battery and another power supply, such as by one or more power supplies that are external to computing device 1100 and connected to computing device 1100 via the one or more external power interfaces. In other examples, some or all of one or more batteries 1124 can be non-rechargeable batteries.

One or more external power interfaces 1126 of power system 1122 can include one or more wired-power interfaces, such as a USB cable and/or a power cord, that enable wired electrical power connections to one or more power supplies that are external to computing device 1100. One or more external power interfaces 1126 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1126, computing device 1100 can draw electrical power from the external power source the established electrical power connection. In some examples, power system 1122 can include related sensors, such as battery sensors associated with the one or more batteries or other types of electrical power sensors.

### Example Methods of Operation

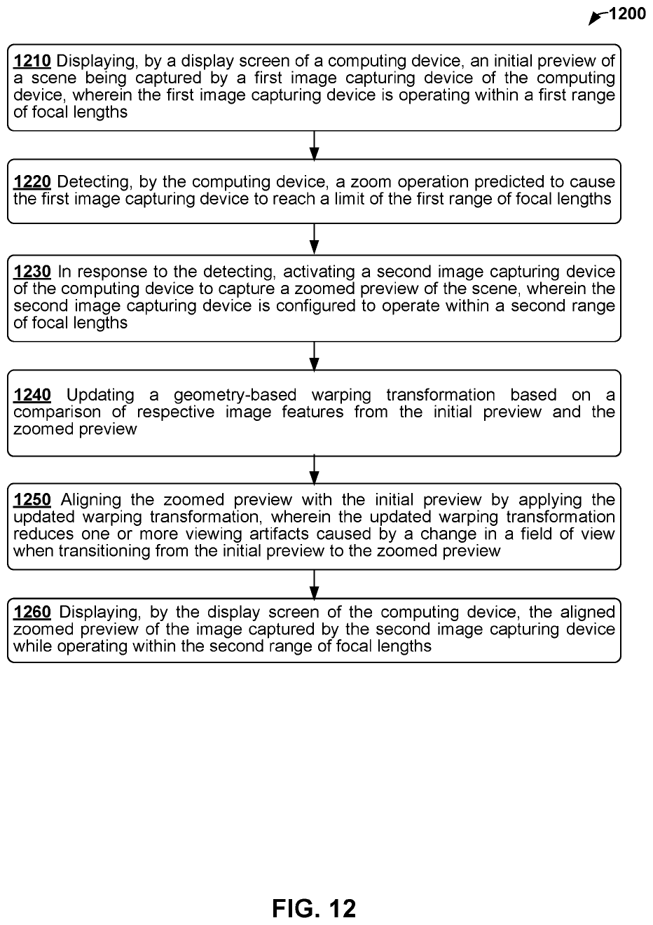

FIG. 12 illustrates a method 1200, in accordance with example embodiments. Method 1200 may include various blocks or steps. The blocks or steps may be carried out individually or in combination. The blocks or steps may be carried out in any order and/or in series or in parallel. Further, blocks or steps may be omitted or added to method 1200.

The blocks of method 1200 may be carried out by various elements of computing device 1100 as illustrated and described in reference to FIG. 11.

Block 1210 includes displaying, by a display screen of a computing device, an initial preview of a scene being captured by a first image capturing device of the computing device, wherein the first image capturing device is operating within a first range of focal lengths.

Block 1220 includes detecting, by the computing device, a zoom operation predicted to cause the first image capturing device to reach a limit of the first range of focal lengths.

Block 1230 includes, in response to the detecting, activating a second image capturing device of the computing device to capture a zoomed preview of the scene, wherein the second image capturing device is configured to operate within a second range of focal lengths.

Block 1240 includes updating a geometry-based warping transformation based on a comparison of respective image features from the initial preview and the zoomed preview.

Block 1250 includes aligning the zoomed preview with the initial preview by applying the updated warping transformation, wherein the updated warping transformation reduces one or more viewing artifacts caused by a change in a field of view when transitioning from the initial preview to the zoomed preview.

Block 1260 includes displaying, by the display screen of the computing device, the aligned zoomed preview of the image captured by the second image capturing device while operating within the second range of focal lengths.

In some embodiments, the comparison of the respective image features includes detecting one or more visual features in the initial preview and the zoomed preview. Such embodiments also include generating, based on the one or more visual features, a visual correspondence between the initial preview and the zoomed preview.

Some embodiments include optimizing the detecting of the one or more visual features and the generating of the visual correspondence by performing asynchronous multi-thread processing comprising receiving one or more images and associated metadata as inputs, and sending visual feature matches and associated metadata as outputs.

In some embodiments, the updating of the geometry-based warping transformation includes correcting frame-based geometric metadata based on the visual correspondence.

In some embodiments, the updating of the geometry-based warping transformation includes estimating a homography from the corrected geometric metadata, and wherein the homography maps a pixel in a plane of a first coordinate system associated with the first image capturing device to a corresponding pixel at the same plane of a second coordinate system associated with the second image capturing device.

In some embodiments, the updating of the geometry-based warping transformation utilizes frame-based data including one or more of an image, a pre-crop of the image, a scene depth, or a calibration parameter respectively associated with the first image capturing device and the second image capturing device. In some embodiments, the calibration parameter includes an auto-focus distance.

In some embodiments, the applying of the updated warping transformation is performed on each frame of the initial preview and a corresponding frame of the zoomed preview in a side-by-side comparison.

In some embodiments, the aligning of the zoomed preview with the initial preview includes aligning, on each frame of the initial preview and a corresponding frame of the zoomed preview, a depth value of a point in image space with a geometric focus distance of the point.

Some embodiments include generating, for each frame of the initial preview and a corresponding frame of the zoomed preview, a bundle adjustment to be applied to one or more camera calibrations, and one or more focal distances.

Some embodiments include generating, for a collection of successive frames, a modified bundle adjustment based on respective bundle adjustments of the successive frames.

Some embodiments include transitioning, by the computing device and based on the updated warping transformation, from the first image capturing device to the second image capturing device.

In some embodiments, the second range of focal lengths could be larger or smaller than the first range of focal lengths, corresponding to the zoom-in or zoom-out operations on the computing device.

In some embodiments, the one or more viewing artifacts include a binocular disparity.

In some embodiments, the updating of the geometry-based warping transformation includes reducing jitter by applying temporal feature matching and tracking.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A computer-implemented method, comprising:
displaying, by a display screen of a computing device, an initial preview of a scene being captured by a first image capturing device of the computing device, wherein the first image capturing device is operating within a first range of focal lengths;
detecting, by the computing device, a zoom operation predicted to cause the first image capturing device to reach a limit of the first range of focal lengths;
in response to the detecting, activating a second image capturing device of the computing device to capture a zoomed preview of the scene, wherein the second image capturing device is configured to operate within a second range of focal lengths;
updating a geometry-based warping transformation based on a comparison of respective image features from the initial preview and the zoomed preview;
aligning the zoomed preview with the initial preview by applying the updated warping transformation, wherein the updated warping transformation reduces one or more viewing artifacts caused by a change in a field of view when transitioning from the initial preview to the zoomed preview; and
displaying, by the display screen of the computing device, the aligned zoomed preview of the image captured by the second image capturing device while operating within the second range of focal lengths.

2. The method of claim 1, wherein the comparison of the respective image features further comprises:
detecting one or more visual features in the initial preview and the zoomed preview; and
generating, based on the one or more visual features, a visual correspondence between the initial preview and the zoomed preview.

3. The method of claim 2, further comprising:
optimizing the detecting of the one or more visual features and the generating of the visual correspondence by performing asynchronous multi-thread processing comprising receiving one or more images and associated metadata as inputs, and sending visual feature matches and associated metadata as outputs.

4. The method of claim 2, wherein the updating of the geometry-based warping transformation comprises:
correcting frame-based geometric metadata based on the visual correspondence.

5. The method of claim 4, wherein the updating of the geometry-based warping transformation comprises estimating a homography from the corrected geometric metadata, and wherein the homography maps a pixel in a plane of a first coordinate system associated with the first image capturing device to a corresponding pixel at the same plane of a second coordinate system associated with the second image capturing device.

6. The method of claim 1, wherein the updating of the geometry-based warping transformation utilizes frame-based data comprising one or more of an image, a pre-crop of the image, a scene depth, or a calibration parameter respectively associated with the first image capturing device and the second image capturing device.

7. The method of claim 6, wherein the calibration parameter comprises an auto-focus distance.

8. The method of claim 1, wherein the applying of the updated warping transformation is performed on each frame of the initial preview and a corresponding frame of the zoomed preview in a side-by-side comparison.

9. The method of claim 1, wherein the aligning of the zoomed preview with the initial preview comprises:
aligning, on each frame of the initial preview and a corresponding frame of the zoomed preview, a depth value of a point in image space with a geometric focus distance of the point.

10. The method of claim 1, further comprising:
generating, for each frame of the initial preview and a corresponding frame of the zoomed preview, a bundle adjustment to be applied to one or more camera calibrations, and one or more focal distances.

11. The method of claim 10, further comprising:
generating, for a collection of successive frames, a modified bundle adjustment based on respective bundle adjustments of the successive frames.

12. The method of claim 1, further comprising:
transitioning, by the computing device and based on the updated warping transformation, from the first image capturing device to the second image capturing device.

13. The method of claim 1, wherein the updating of the geometry-based warping transformation further comprises:
reducing jitter by applying temporal feature matching and tracking.

14. A computing device, comprising:
a display screen;
a first image capturing device configured to operate within a first range of focal lengths;
a second image capturing device configured to operate within a second range of focal lengths;
one or more processors; and
data storage, wherein the data storage has stored thereon computer-executable instructions that, when executed by the one or more processors, cause the mobile device to carry out functions comprising:
displaying, by the display screen, an initial preview of a scene being captured by the first image capturing device;
detecting, by the computing device, a zoom operation likely to cause the first image capturing device to reach a limit of the first range of focal lengths;
in response to the detecting, activating the second image capturing device to capture a zoomed preview of the scene;
updating a geometry-based warping transformation based on a comparison of respective image features from the initial preview and the zoomed preview;
aligning the zoomed preview with the initial preview by applying the updated warping transformation, wherein the updated warping transformation reduces one or more viewing artifacts caused by a change in a field of view when transitioning from the initial preview to the zoomed preview; and
displaying, by the display screen of the computing device, the aligned zoomed preview of the image captured by the second image capturing device while operating within the second range of focal lengths.

15. The computing device of claim 14, wherein the functions for the comparison of the respective image features further comprise:
detecting one or more visual features in the initial preview and the zoomed preview; and
generating, based on the one or more visual features, a visual correspondence between the initial preview and the zoomed preview.

16. The computing device of claim 15, wherein the functions for the updating of the geometry-based warping transformation further comprise:
correcting frame-based geometric metadata based on the visual correspondence.

17. The computing device of claim 16, wherein the functions for the updating of the geometry-based warping transformation comprise estimating a homography from the corrected geometric metadata, and wherein the homography maps a pixel in a plane of a first coordinate system associated with the first image capturing device to a corresponding pixel at the same plane of a second coordinate system associated with the second image capturing device.

18. The computing device of claim 14, wherein the updating of the geometry-based warping transformation utilizes frame-based data comprising one or more of an image, a pre-crop of the image, a scene depth, or a calibration parameter respectively associated with the first image capturing device and the second image capturing device.

19. The computing device of claim 14, wherein the functions for applying of the updated warping transformation are performed on each frame of the initial preview and a corresponding frame of the zoomed preview in a side-by-side comparison.

20. The computing device of claim 19, wherein the functions for the aligning of the zoomed preview with the initial preview comprise:
aligning, on each frame of the initial preview and a corresponding frame of the zoomed preview, a depth value of a point in image space with a geometric focus distance of the point.

21. The computing device of claim 14, wherein the functions for the updating of the geometry-based warping transformation further comprise:
reducing jitter by applying temporal feature matching and tracking.

22. A non-transitory computer-readable medium comprising program instructions executable by one or more processors to cause the one or more processors to perform operations comprising:
displaying, by a display screen of a computing device, an initial preview of a scene being captured by a first image capturing device of the computing device, wherein the first image capturing device is operating within a first range of focal lengths;
detecting, by the computing device, a zoom operation likely to cause the first image capturing device to reach a limit of the first range of focal lengths;
in response to the detecting, activating the second image capturing device to capture a zoomed preview of the scene, wherein the second image capturing device is configured to operate within a second range of focal lengths;
updating a geometry-based warping transformation based on a comparison of respective image features from the initial preview and the zoomed preview;
aligning the zoomed preview with the initial preview by applying the updated warping transformation, wherein the updated warping transformation reduces one or more viewing artifacts caused by a change in a field of view when transitioning from the initial preview to the zoomed preview; and
displaying, by the display screen of the computing device, the aligned zoomed preview of the image captured by the second image capturing device while operating within the second range of focal lengths.
